(19) United States
(12) Patent Application Publication
(10) Pub. No.: US 2024/0303516 A1
(43) Pub. Date: Sep. 12, 2024

(54) VECTOR AS A SERVICE

(71) Applicant: HUBSPOT, INC., Cambridge, MA (US)

(72) Inventors: Andrea BERGONZO, Dublin (IE); Yiping DENG, Dublin (IE); Srubin Sethu Madhavan, Cambridge, MA (US)

(21) Appl. No.: 18/666,248

(22) Filed: May 16, 2024

Related U.S. Application Data
(63) Continuation-in-part of application No. 18/217,594, filed on Jul. 2, 2023.
Application No. 18/217,594 is a continuation of application No. 17/882,950, filed on Aug. 8, 2022, now Pat. No. 11,727,287.
Application No. 17/882,950 is a continuation of application No. 16/716,688, filed on Dec. 17, 2019, now Pat. No. 11,449,775.
(60) Provisional application No. 62/785,544, filed on Dec. 27, 2018.

(51) Int. Cl. G06N 5/04; G06N 20/00

(52) U.S. Cl. CPC G06N 5/04; G06N 20/00

(57) ABSTRACT

Techniques are provided for implementing a vector as a service. A first vector is generated, through a first pipeline, using a first embedding model hosted by an inference service. The first vector is assigned a first model identifier of the first embedding model, and is stored within storage. A second pipeline is constructed to utilize a second embedding model having a second model identifier. The first vector is extracted from the storage, and is used to generate an embedding storage request event to reindex and port the first vector from being embedded by the first embedding model to being embedded by the second embedding model. In this way, the second pipeline is used to execute the embedding storage request event to port the first vector into a second vector embedded by the second embedding model for storage within a vector database.

### CROSS-REFERENCE TO RELATED APPLICATION(S)

This application claims priority to and is a continuation-in-part of U.S. patent application Ser. No. 18/217,594, filed Jul. 2, 2023, entitled “Multi-Client Service System Platform,”, which claims priority to U.S. Pat. No. 11,727,287, filed Aug. 8, 2022, entitled “Multi-Client Service System Platform,” which application claims priority to U.S. Pat. No. 11,449,775, filed Dec. 17, 2019, entitled “Multi-Client Service System Platform,” which claims priority to U.S. Provisional Patent Application No. 62/785,544, filed Dec. 27, 2018, entitled “Multi-Client Service System Platform,” which are hereby incorporated by reference.

### BACKGROUND

Many services utilize vectors created by embedding models to perform various functions. For example, a recommendation system utilizes vectors (e.g., user and item embeddings) to generate personalized recommendations based on user preferences. An image and video search feature utilizes vectors (e.g., embeddings of image and video features) to quickly search and retrieve similar images or videos. Natural language processing uses vectors (e.g., word embeddings) to perform semantic search and text classification. Anomaly detection uses vectors (e.g., vectors of normal/expected behavior) to detect anomalies in real-time.

### DESCRIPTION OF THE DRAWINGS

Embodiments of the present technology will be described and explained through the use of the accompanying drawings in which:

FIG. 1 is a block diagram illustrating an embodiment of a system for generating vectors in accordance with an embodiment of the present technology.

FIG. 2 is a flow chart illustrating an embodiment of a method for implementing a vector as a service in accordance with various embodiments of the present technology.

FIG. 3 is a block diagram illustrating an embodiment of a system for implementing a vector as a service in accordance with various embodiments of the present technology.

FIG. 4 is a block diagram illustrating an embodiment of a system for implementing a vector as a service for utilization by a chatbot in accordance with various embodiments of the present technology.

FIG. 5 is a block diagram illustrating an embodiment of a system for implementing a vector as a service for utilization by a deduplication service in accordance with various embodiments of the present technology.

FIG. 6 is a block diagram illustrating an embodiment of a system for implementing a vector as a service for reindexing and porting existing vectors in accordance with various embodiments of the present technology.

FIG. 7 is a block diagram illustrating an embodiment of a system for implementing a vector as a service for embedding and storing vectors within a vector database in accordance with various embodiments of the present technology.

FIG. 8 is a block diagram illustrating an embodiment of a system for implementing a vector as a service for retrieving a top K matches for a query in accordance with various embodiments of the present technology.

FIG. 9 is an example of a computer readable medium in accordance with various embodiments of the present technology.

FIG. 10 is a block diagram illustrating an example of a computing device in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

Techniques are provided for hosting a vector as a service. The vector as a service provides dynamic pipelines around embeddings such that different pipelines are dynamically constructed and used to embed data as vectors using different embedding models. The vector as a service provides a technical solution to technical problems of conventional embedding model services. Conventional embedding model services are unable to adequately solve problems relating to reindexing vectors when new embedding models become available. For example, a first embedding model may be developed and deployed. The first embedding model may be capable of embedding vectors used to identify duplicate objects within a customer relationship management (CRM) system at 80% accuracy. A second embedding model may be subsequently developed and deployed. The second embedding model may be capable of embedding vectors used to identify duplicate objects within the CRM system at 92% accuracy. However, all of the vectors created by the first embedding model are not compatible with and cannot be used to achieve the 92% accuracy provided by the second embedding model. This results in a technical problem of how to reindex the vectors that were generated using the first embedding model, which could include a significant number of vectors created over weeks, months, or even years.

The disclosed vector as a service solves this technical problem of reindexing vectors by implementing reindexing functionality to re-embed and port already embedded/indexed data in vectors from being embedded by the first embedding model to new vectors (a new index) embedded by the second embedding model. The vector as a service is capable of dynamically reindexing existing vectors (historic vectors), that were previously embedded utilizing the first embedding model (e.g., an older embedding model), as new vectors embedded with the second embedding model (e.g., a newer embedding model). The vector as a service is also capable of dynamically embedding incoming data utilizing the second embedding model (e.g., the new embedding model). In this way, both existing vectors and newly created vectors are embedded using the second embedding model so that the vectors can obtain the benefits, accuracy, and efficiency provided by the second embedding model compared to the first embedding model.

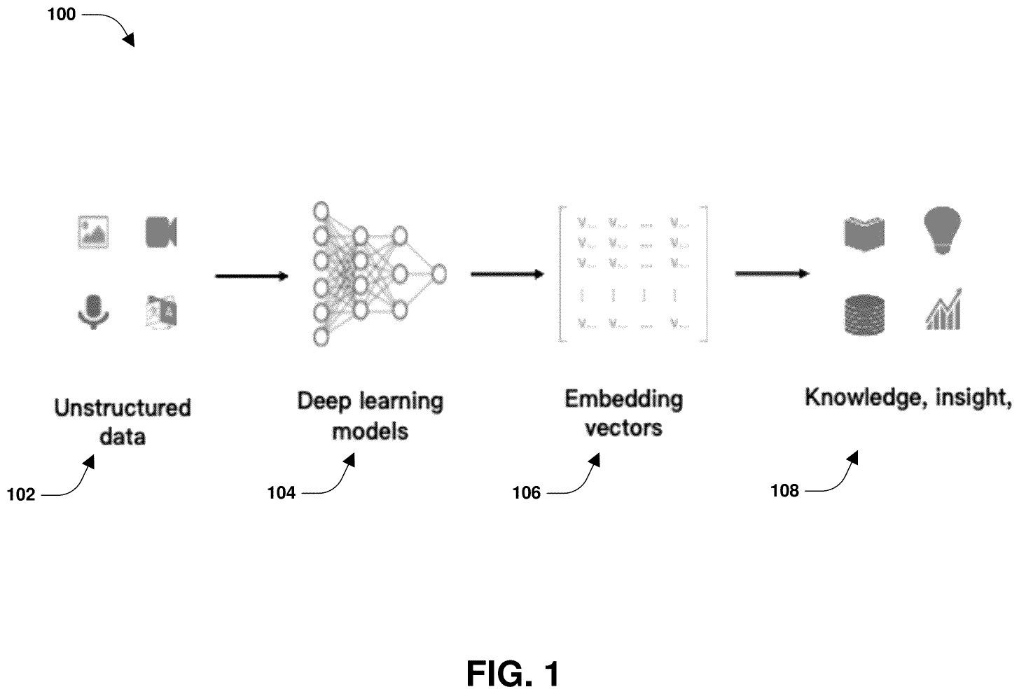

FIG. 1 is a block diagram illustrating an embodiment of a system 100 for generating vectors in accordance with an embodiment of the present technology. The system 100 may receive data 102 from various data sources, such as images, audio, video, or any other type of data such as unstructured data. Various types of machine learning models 104 such as deep learning models or any other type of model may be used to generate vectors 106 such as embedding vectors generated by embedding models. Various services may utilize the vectors 106 to perform actions 108 such as generating knowledge or insight into the data represented by the vectors 106.

Many different types of services may utilize the vectors 106 created by models 104. For example, a recommendation system utilizes the vectors 106 (e.g., user and item embeddings) to generate personalized recommendations based on user preferences. An image and video search feature utilizes the vectors 106 (e.g., embeddings of image and video features) to quickly search and retrieve similar images or videos. Natural language processing uses the vectors 106 (e.g., word embeddings) to perform semantic search and text classification. Anomaly detection uses the vectors 106 (e.g., vectors of normal/expected behavior) to detect anomalies in real-time. In some embodiments, deduplication services, chatbots, and/or other services may also utilize the vectors 106. In some embodiments, the vectors 106 are used to solve a fundamental aspect of machine learning, relating to how to approximate the nearest neighbor for a vector.

The vectors 106 may be created, stored, and reindexed by the disclosed vector as a service. A technical use case for the vector as a service is semantic search. Semantic search involves understanding the meaning behind words and phrases, rather than just searching for exact matches. One way to enable semantic search is through the use of word embeddings, which are a way to represent words as the vectors 106 in a high-dimensional space. Vector databases can be used to store these word embeddings, which can then be queried to perform semantic search. For example, if a user searches for “dog,” a semantic search engine could retrieve all documents or web pages that contain similar word embeddings, such as “cat,” “pet,” or “animal.” Vector databases can also be used for text classification, which involves categorizing documents or text based on their content. By storing pre-trained embeddings for different categories, such as “sports,” “politics,” or “entertainment,” vector databases can quickly classify new text based on its semantic similarity to each category. Vector databases are a powerful tool for enabling semantic search and text classification, and can be used in a wide range of applications, from search engines to customer support chatbots.

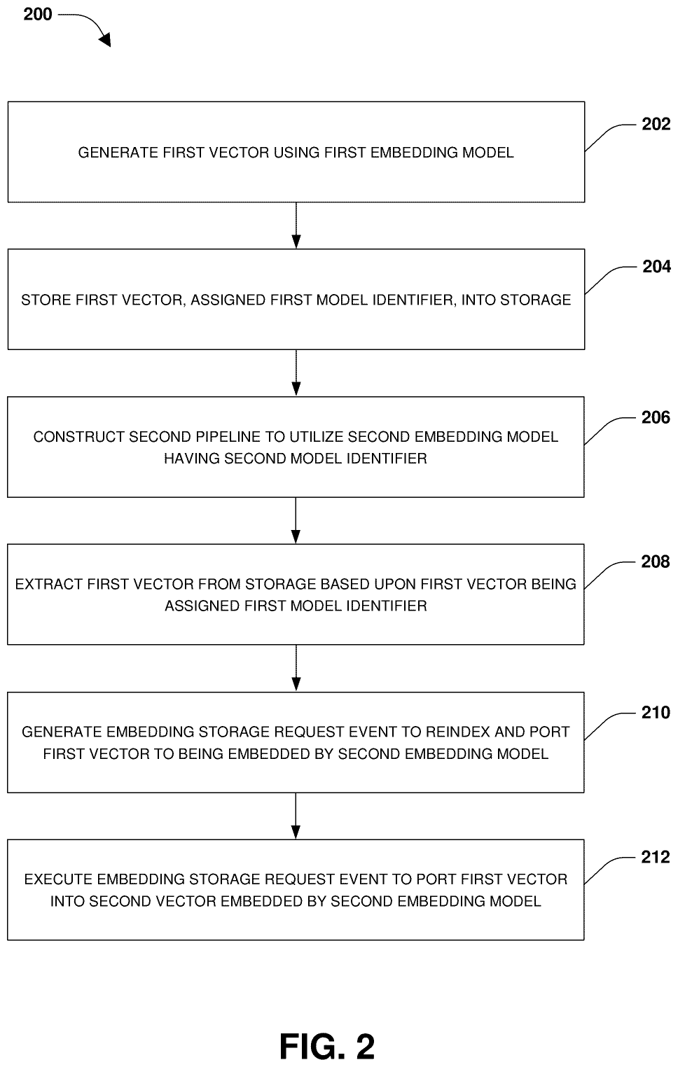

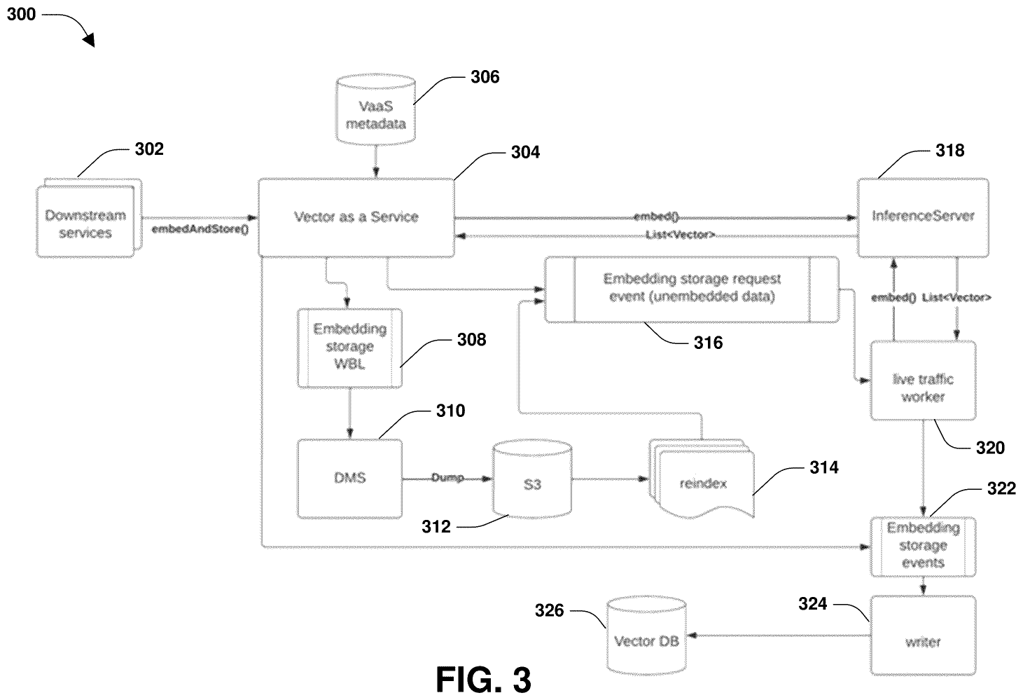

FIG. 2 is a flow chart illustrating an embodiment of a method 200 for implementing a vector as a service 304, which is described in conjunction with system 300 of FIG. 3. The vector as a service 304 may facilitating the creation of vectors on behalf of downstream services 302 using embedding models hosted by an inference server 318. The vectors may be stored in a vector database 326 accessible to the downstream services 302 for perform various functionality such as generating personalized recommendations, identifying and retrieving similar images or videos, semantic search and text classification, anomaly detection, deduplication, chatbots, approximating k nearest neighbors, deduplication, etc. The vector as a service 304 may utilize metadata 306 for operation. The metadata 306 may relate to underling embedding models that will be used by the vector as a service 304, which may include bindings between embedding models and indexes.

During operation 202 of method 200, the vector as a service 304 may receive a request from a downstream service to embed and store data. The vector as a service 304 may utilize the metadata 306 to determine that a first embedding model hosted by the inference server 318 is to be used to embed the data as a first vector. Accordingly, the vector as a service 304 may utilize a first pipeline, bound to the first embedding model, to generate the first vector using the first embedding model hosted by the inference server 318.

During operation 204 of method 200, the vector as a service 304 may store the first vector through an embedding storage write back log 308 that utilizes a dataset management service 310 to store the first vector in storage 312 such as S3 storage used for long term storage of vectors. The first vector may be assigned a first model identifier of the first embedding model, which may be used by a reindexer component 314 to subsequently reindex the first vector. In some embodiments, raw information (e.g., unembedded data of the request) may be stored within the storage 312 and/or within the vector database 326 into which the first vector may be stored. Information/instructions on how to recompute the embeddings from the raw information may be retained with the raw information. This may be achieved by defining the first pipeline to push data into the vector database 326 (e.g., storing the first model identifier/version of the first embedding model, the raw information, the information/instructions on how to recompute the embeddings of the first vector, and/or other data into the vector database 326). Thus, when a new embedding model becomes available, the previously embedded data may be re-embedded into a new index using the new embedding model that processes the raw information representing the unembedded data that was previously embedded into the first vector.

A second embedding model may become available through the inference server 318. In some embodiments, the second embedding model may be a newer/improved version of the first embedding model (e.g., the second embedding model may generate more accurate outputs than the first embedding model). The vector as a service 304 may reindex/re-embed previously created vectors, such as the first vector embedded using the first embedding model, using the second embedding model in order to gain the benefits such as improved accuracy provided by the second embedding model. Accordingly, the vector as a service 304 constructs a second pipeline to utilize the second embedding model having a second model identifier, during operation 206 of method 200. The second pipeline may be constructed to utilize information to reindex vectors previously embedded by the first embedding model (e.g., the first model identifier/version of the first embedding model, the raw information, the information/instructions on how to recompute the embeddings of the first vector, etc.).

The second pipeline may be defined with instructions on inputting data into the second embedding model, selection criteria for choosing the second embedding model (e.g., certain types of data are to be embedded by the second embedding model, data from certain downstream services 302 is to be embedded by the second embedding model, data previously embedded by a particular embedding model is to be embedded by the second embedding model, data previously embedded within a particular timeframe is to be embedded by the second embedding model, etc.), and/or criteria for selecting an index. The second pipeline may be defined with a name that is utilized as a prefix of indices. The second pipeline may be defined with a second pipeline version different than a first pipeline version defined for the first pipeline. The second pipeline may be defined to receive query data and/or item data, which may be routed into an index associated with an endpoint of an embedding model. The second pipeline may be defined with a vector size specifying dimensionality for a second vector that will be created through the second pipeline. The second pipeline may be defined with a distance function for calculating a distance between two vectors created through the second pipeline.

During operation 208 of method 200, the reindexer component 314 extracts the first vector from the storage 312 based upon the first vector being assigned the first model identifier and/or satisfying other criteria/selection criteria for the first vector to be reindexed using the second embedding model. During operation 210 of method 200, the reindexer component 314 generates an embedding storage request event 316 with unembedded data (e.g., raw information associated with the first vector). The embedding storage request event 316 can be used to reindex and port the first vector from being embedded by the first embedding model to being embedded by the second embedding model.

During operation 212 of method 200, the embedding storage request event 316 is executed to port the first vector into the second vector embedded by the second embedding model. In some embodiments, the unembedded data associated with the first vector and/or other information (e.g., the first model identifier/version of the first embedding model, the raw information, the information/instructions on how to recompute the embeddings of the first vector, etc.) is used to generate the second vector. In some embodiments, a dependency between indices is identified, and models corresponding to the dependency are reindexed together as part of porting the first vector (e.g., two models may have been used to generate indices associated with embedding data). An embedding storage event 322 is performed by a writer 324 to store the second vector into the vector database 326. In this way, the vector as a service 304 can port vectors from being embedded by older embedding models to being embedded by newer embedding models.

In some embodiments, the vector as a service 304 is capable of dynamically generating pipelines to route embedding requests (e.g., incoming embedding requests received from the downstream services 302) to select embedding models such as the second embedding model. The vector as a service 304 may utilize the second pipeline to generate a new embedding storage request event for embedding data of the request using a second embedding model to create a vector. The metadata 306 may indicate that the second embedding model is preferred over the first embedding model for embedding the data of the request (e.g., the second embedding model is preferred for the downstream service that created the request, is preferred for a type of data to embed, etc.). A live traffic worker 320 may execute the new embedding storage request event by invoking the inference server 318 to utilize the second embedding model to embed the data to create a vector that is stored by the writer 324 into the vector database 326.

Various types of downstream services 302 may utilize the vector as a service 304. In some embodiments, a recommendation service may utilize the vectors within the vector database 326 to construct and provide content recommendations to users. In some embodiments, a service may utilize the vectors within the vector database 326 to execute a query for query item retrieval (e.g., retrieving a photo based upon a user query). In some embodiments, a service may utilize the vectors within the vector database 326 to perform a similarity search for entities represented by the vectors (e.g., identify two objects within a CRM database that are similar or the same). In some embodiments, a service may utilize the vectors within the vector database 326 to process service tickets using information derived from entities (e.g., objects within the CRM database) represented by the vectors.

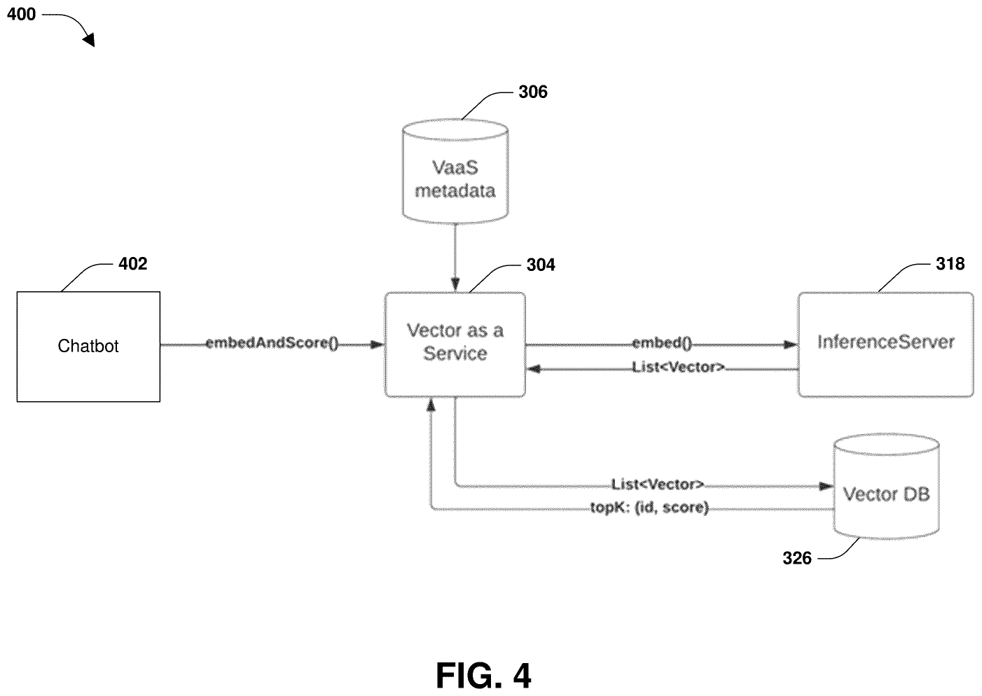

In some embodiments, a chatbot service 402 may utilize artificial intelligence (e.g., ChatGPT, an AI/ML model, etc.) to generate contextual and personalized responses for conversations with users, as illustrated by system 400 of FIG. 4. At a first point in time (e.g., before creation of the second embedding model), the chatbot service 402 may utilize the first vector and/or other vectors (e.g., other vectors embedded using the first embedding model) to generate a first response. At a second point in time (e.g., after the vector as a service 304 has reindexed vectors using the second embedding model), the chatbot service 402 may utilize the second vector and/or other vectors (e.g., other vectors embedded using the second embedding model) to generate a second response.

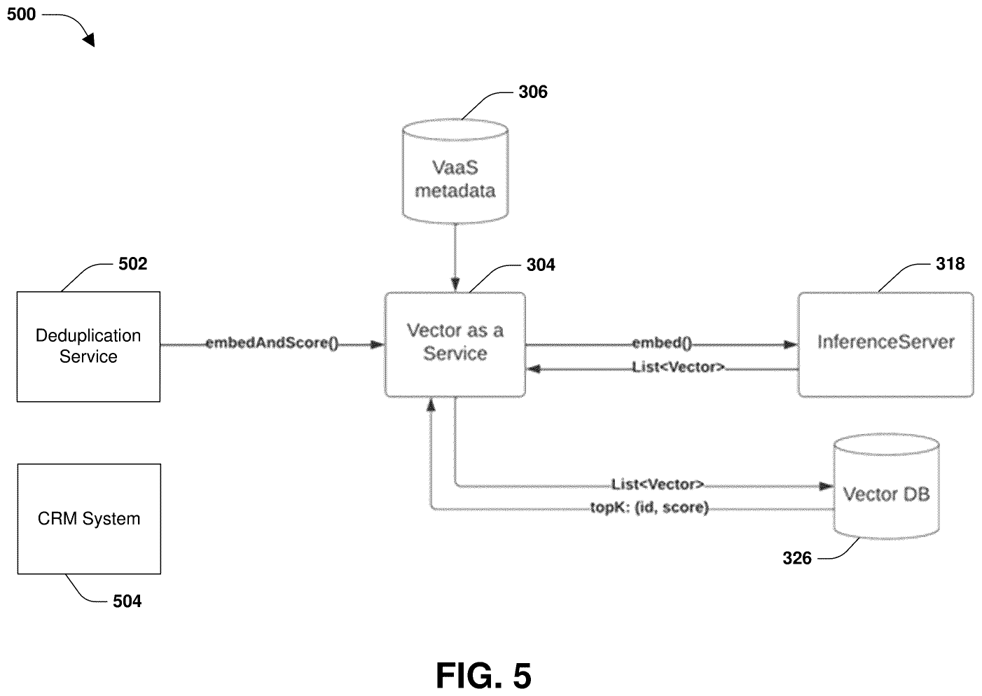

In some embodiments, a deduplication service 502 may implement deduplication processes to deduplicate objects within a CRM system 504 (e.g., objects representing customers, companies, contacts, service tickets, etc.), as illustrated by system 500 of FIG. 5. The deduplication service 502 may execute a first deduplication process to deduplicate objects within the CRM system 504 by comparing vectors representing two objects within the CRM system 504 (e.g., vectors embedded using the first embedding model based upon the first deduplication process being executed before the vector as a service 304 has reindexed vectors using the second embedding model) to determine whether the two objects within the CRM system 504 are duplicates. At a subsequent point in time, the deduplication service 502 may execute a second deduplication process to deduplicate objects within the CRM system 504 by comparing vectors representing two objects within the CRM system 504 (e.g., vectors embedded using the second embedding model based upon the second deduplication process being executed after the vector as a service 304 has reindexed vectors using the second embedding model) to determine whether the two objects within the CRM system 504 are duplicates. If two objects are identified as duplicates, then one of the objects may be removed from the CRM system 504 to reduce storage otherwise wasted in storing redundant objects.

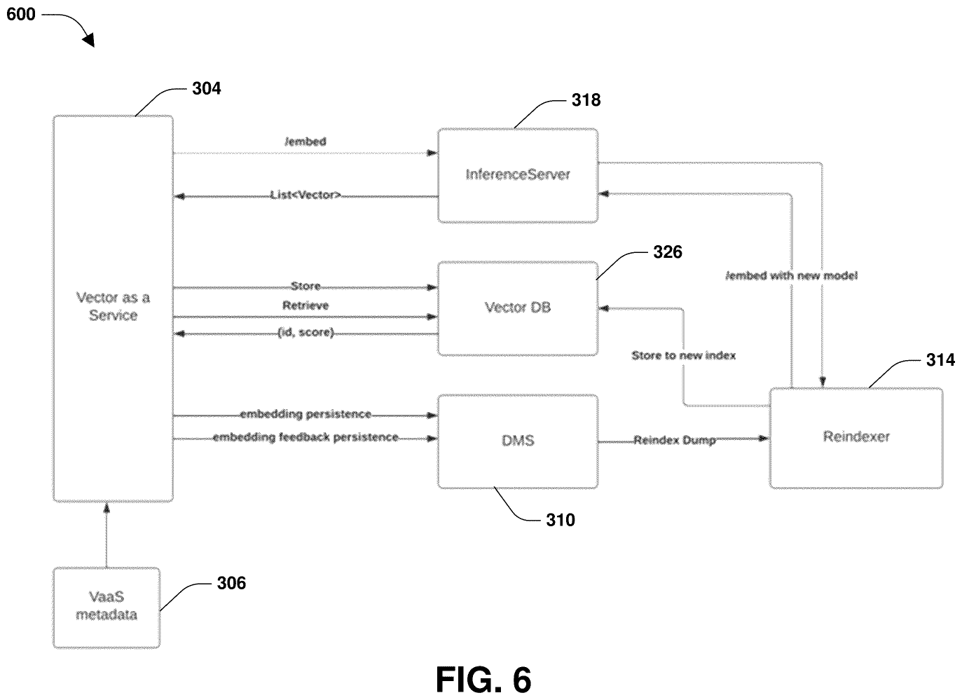

FIG. 6 is a block diagram illustrating an embodiment of a system 600 for implementing the vector as a service 304. The vector as a service 304 utilizes the metadata 306 for operation. The vector as a service 304 may transmit an embed request to the inference server 318 that generates a list of one or more vectors that are returned to the vector as a service 304. The vector as a service 304 may implement a store operation to store the one or more vectors within the vector database 326. The vector as a service 304 may implement a retrieve operation to retrieve a vector from the vector database 326. The vector as a service 304 may query the vector database 326 (e.g., using the retrieve operation) to identify a vector represented by an identifier and a score (e.g., a vector matching a query such that the score represents how close the vector matches the query). The vector as a service 304 may transmit an embedding persistence operation to the dataset management service 310 to persistently store an embedding/vector within the storage 312. The vector as a service 304 may transmit an embedding feedback persistence operation to the dataset management service 310 to persistently store feedback for an embedding/vector within the storage 312 (e.g., feedback as to whether the embedding/vector is accurate or not).

The reindexer component 314 may retrieve a dump of vectors, embedded by an embedding model, from the storage 312 through the dataset management service 310 for reindexing. The reindexer component 314 invokes the inference server 318 to reindex and port the vectors to create reindexed vectors embedded by a different embedding model. The reindexer component 314 stores the reindexed vectors to a new index(es) within the vector database 326. In this way, previously embedded/existing vectors may be reindexed and ported as reindexed vectors embedded by a different embedding model.

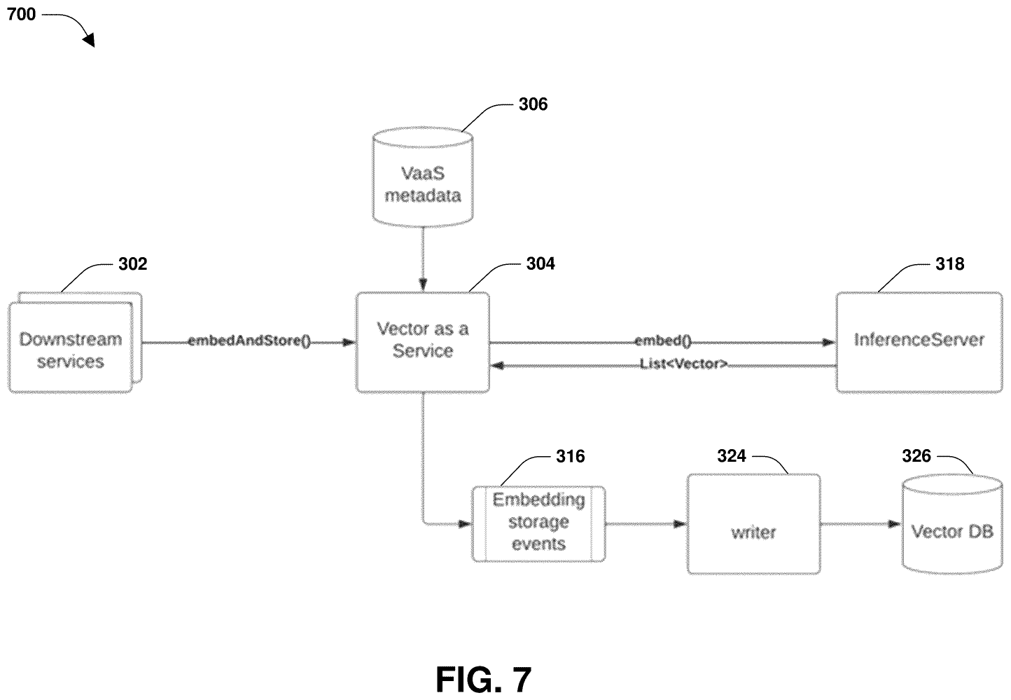

FIG. 7 is a block diagram illustrating an embodiment of a system 700 for implementing the vector as a service 304 for embedding and storing vectors within the vector database 326. The vector as a service 304 may receive a request from a downstream service to embed and store data as a vector within the vector database 326. Utilizing the metadata 306, the vector as a service 304 may construct a pipeline and transmit an embed operation to the inference server 318 to generate a list of one or more vectors within which the data has been embedded using an embedding model. The vector as a service 304 generates an embedding storage event that is executed by the writer 324 to store the one or more vectors within the vector database 326.

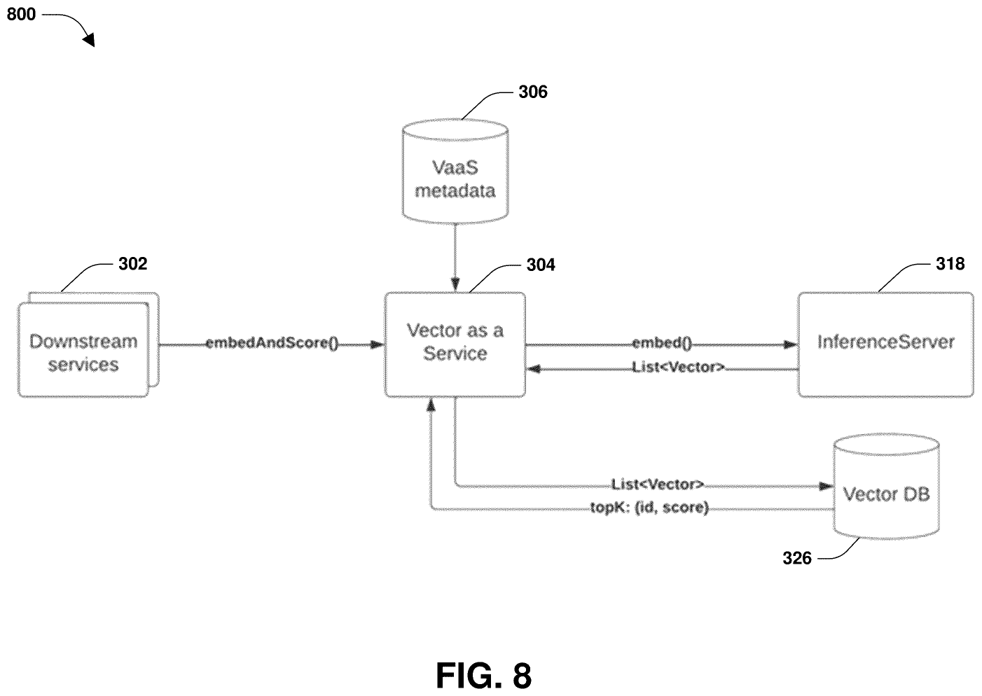

FIG. 8 is a block diagram illustrating an embodiment of a system 800 for implementing the vector as a service 304 for retrieving a top K matches for a query. The vector as a service 304 may receive a request from a downstream service. The request may include unembedded data. The vector as a service 304 transmits an embed request with the unembedded data to the inference server 318 that returns a list of one or more vectors created by an embedding model that embedded the unembedded data to create the one or more vectors. The vector as a service 304 queries the vector database 326 using the one or more vectors to identify a top K matching vectors that are similar to the one or more vectors. Each of the top K matching vectors may be represented by an identifier of a vector and a score indicating how similar the vector is to the one or more vectors.

In some embodiments, a method for implementing vector as a service is provided. The method includes generating, utilizing a first pipeline of the vector as a service, a first vector using a first embedding model hosted by an inference service; storing, through a dataset management service, the first vector into storage, wherein the first vector is assigned a first model identifier of the first embedding model; constructing a second pipeline of the vector as a service to utilize a second embedding model having a second model identifier; extracting, by a reindexer component, the first vector from the storage based upon the first vector being assigned a first model identifier different than the second model identifier of the second embedding model hosted by the inference service; generating, by the reindexer component, an embedding storage request event to reindex and port the first vector from being embedded by the first embedding model to being embedded by the second embedding model; and executing, using the second pipeline, the embedding storage request event to port the first vector into a second vector embedded by the second embedding model for storage within a vector database.

In some embodiments, the method includes executing a first deduplication process to deduplicate objects within a customer relationship management (CRM) system, wherein the first deduplication process compares the first vector with a different vector to determine whether to deduplicate two objects within the CRM system.

In some embodiments, the method includes executing a first deduplication process to deduplicate objects within a customer relationship management (CRM) system, wherein the first deduplication process compares the first vector with a different vector to determine whether to deduplicate two objects within the CRM system; and executing a second deduplication process subsequent the first deduplication process, wherein the second deduplication process compares the second vector with a vector to determine whether to deduplicate the two objects within the CRM system.

In some embodiments, the method includes hosting a chatbot that utilizes artificial intelligence to generate contextual and personalized responses for conversations with users, wherein the artificial intelligence utilizes the first vector to generate a first response.

In some embodiments, the method includes hosting a chatbot that utilizes artificial intelligence to generate contextual and personalized responses for conversations with users, wherein the artificial intelligence utilizes the first vector to generate a first response; and utilizing, by the artificial intelligence, the second vector to generate a second response.

In some embodiments, the method includes in response to receiving a request from a downstream service for embedding data of the request into a vector, executing, using the second pipeline, a new embedding storage request event to embed the data of the request using the second embedding model to create the vector based upon the second model identifier indicating that the second embedding model is preferred over using the first embedding model associated with the first model identifier.

In some embodiments, the method includes defining the second pipeline to include instructions on inputting data into the second embedding model, selection criteria for choosing the second embedding model, and criteria for selecting an index.

In some embodiments, the method includes defining a name for the second pipeline, wherein the name is utilized as a prefix of indices.

In some embodiments, the method includes defining a first pipeline version for the first pipeline and a second pipeline version for the second pipeline.

In some embodiments, the method includes defining the second pipeline to receive query data and item data, wherein the second pipeline routes the query data and the item data into an index associated with an endpoint.

In some embodiments, the method includes defining the second pipeline with a vector size specifying a dimensionality for the second vector stored into the vector database.

In some embodiments, the method includes defining the second pipeline with a distance function for calculating a distance between two vectors created through the second pipeline.

In some embodiments, the method includes in response to identifying a dependency between indices during porting of a vector, reindexing a first model and a second model, corresponding to the dependency, together as part of porting the vector.

In some embodiments, a computing device is provided. The computing device comprises a memory comprising machine executable code; and a processor coupled to the memory, the processor configured to execute the machine executable code to cause the processor to perform operations including generating, utilizing a first pipeline of the vector as a service, a first vector using a first embedding model hosted by an inference service; storing, through a dataset management service, the first vector into storage, wherein the first vector is assigned a first model identifier of the first embedding model; constructing a second pipeline of the vector as a service to utilize a second embedding model having a second model identifier; extracting, by a reindexer component, the first vector from the storage based upon the first vector being assigned a first model identifier different than the second model identifier of the second embedding model hosted by the inference service; generating, by the reindexer component, an embedding storage request event to reindex and port the first vector from being embedded by the first embedding model to being embedded by the second embedding model; and executing, using the second pipeline, the embedding storage request event to port the first vector into a second vector embedded by the second embedding model for storage within a vector database.

In some embodiments, the operations include utilizing, by a recommendation service, vectors within the vector database to construct and provide a content recommendation to a user.

In some embodiments, the operations include utilizing, by a service, vectors within the vector database to identify a set of nearest neighbors for use by the service to perform a task.

In some embodiments, the operations include utilizing, by a service, vectors within the vector database to execute a query for query item retrieval.

In some embodiments, a non-transitory machine readable medium is provided. The non-transitory machine readable medium comprises instructions, which when executed by a machine, causes the machine to perform operations including generating, utilizing a first pipeline of the vector as a service, a first vector using a first embedding model hosted by an inference service; storing, through a dataset management service, the first vector into storage, wherein the first vector is assigned a first model identifier of the first embedding model; constructing a second pipeline of the vector as a service to utilize a second embedding model having a second model identifier; extracting, by a reindexer component, the first vector from the storage based upon the first vector being assigned a first model identifier different than the second model identifier of the second embedding model hosted by the inference service; generating, by the reindexer component, an embedding storage request event to reindex and port the first vector from being embedded by the first embedding model to being embedded by the second embedding model; and executing, using the second pipeline, the embedding storage request event to port the first vector into a second vector embedded by the second embedding model for storage within a vector database.

In some embodiments, the operations include utilizing, by a service, vectors within the vector database to perform a similarity search for entities represented by the vectors.

In some embodiments, the operations include utilizing, by a service, vectors within the vector database to process service tickets with information derived from entities represented by the vectors.

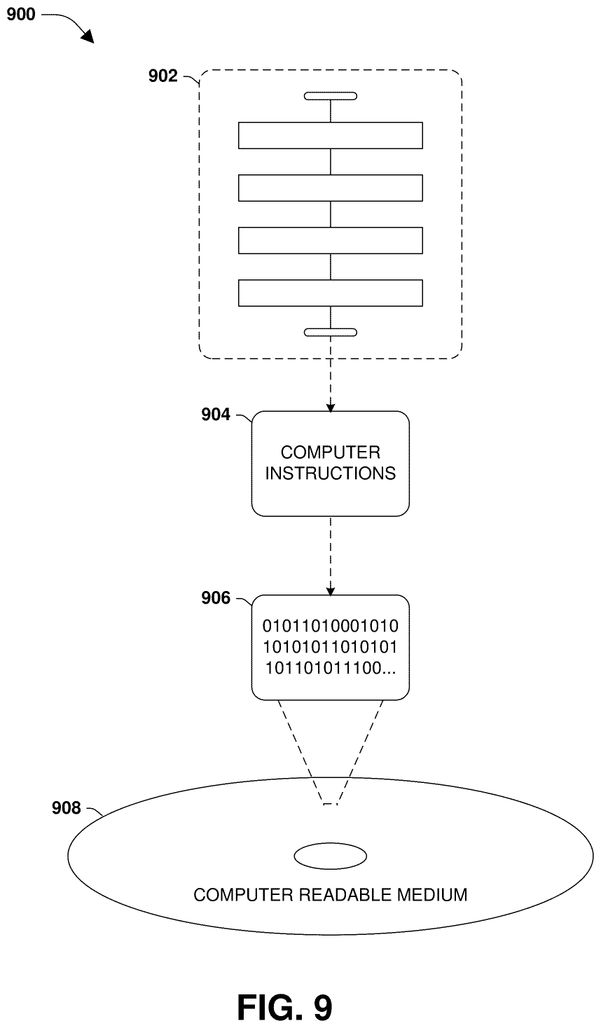

Still another embodiment involves a computer-readable medium comprising processor-executable instructions configured to implement one or more of the techniques presented herein. An example embodiment of a computer-readable medium or a computer-readable device is illustrated in FIG. 9, wherein the implementation 900 comprises a computer-readable medium 908, such as a CD-R, DVD-R, flash drive, a platter of a hard disk drive, etc., on which is encoded computer-readable data 906. This computer-readable data 906, such as binary data comprising at least one of a zero or a one, in turn comprises a set of computer instructions 904 configured to operate according to one or more of the principles set forth herein. In some embodiments, the processor-executable computer instructions 904 are configured to perform a method 902 such as method 200 of FIG. 2, for example. In some embodiments, the processor-executable instructions 904 are configured to implement a system such as system 300 of FIG. 3, system 400 of FIG. 4, system 500 of FIG. 5, system 600 of FIG. 6, system 700 of FIG. 7, and/or system 800 of FIG. 8, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

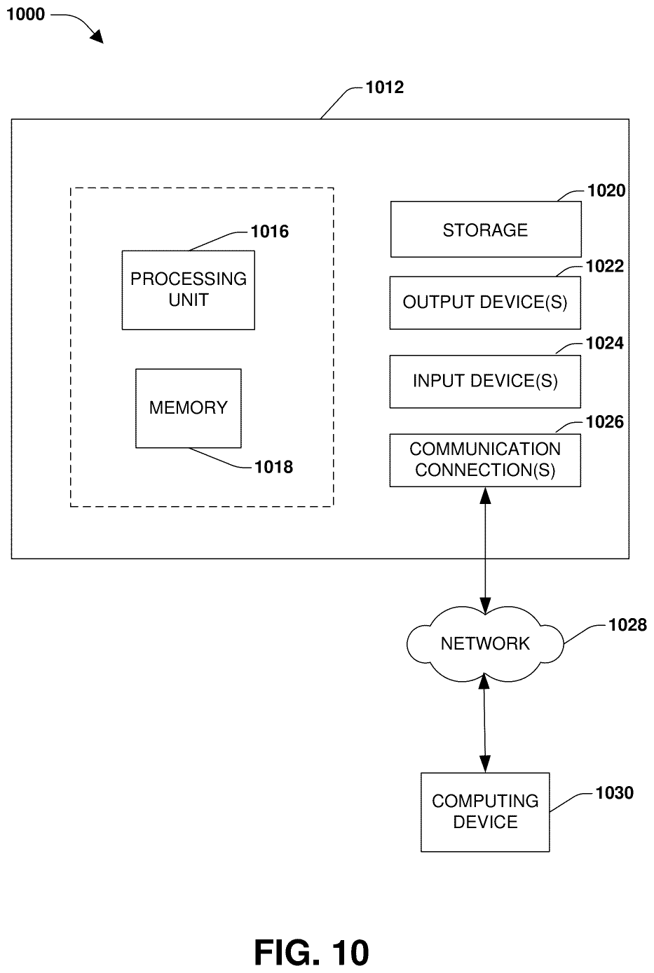

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In some embodiments, the computing device 1012 utilizes an architecture corresponding to Front-end in NextJS/React. Back-end in Python. Database in MySQL.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Computer storage media does not, however, include propagated signals. Rather, computer storage media excludes propagated signals. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via a network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for implementing vector as a service, comprising:
generating, utilizing a first pipeline of the vector as a service, a first vector using a first embedding model hosted by an inference service;
storing, through a dataset management service, the first vector into storage, wherein the first vector is assigned a first model identifier of the first embedding model;
constructing a second pipeline of the vector as a service to utilize a second embedding model having a second model identifier;
extracting, by a reindexer component, the first vector from the storage based upon the first vector being assigned a first model identifier different than the second model identifier of the second embedding model hosted by the inference service;
generating, by the reindexer component, an embedding storage request event to reindex and port the first vector from being embedded by the first embedding model to being embedded by the second embedding model; and
executing, using the second pipeline, the embedding storage request event to port the first vector into a second vector embedded by the second embedding model for storage within a vector database.

2. The method of claim 1, comprising:
executing a first deduplication process to deduplicate objects within a customer relationship management (CRM) system, wherein the first deduplication process compares the first vector with a different vector to determine whether to deduplicate two objects within the CRM system.

3. The method of claim 2, comprising:
executing a second deduplication process subsequent the first deduplication process, wherein the second deduplication process compares the second vector with a vector to determine whether to deduplicate the two objects within the CRM system.

4. The method of claim 1, comprising:
hosting a chatbot that utilizes artificial intelligence to generate contextual and personalized responses for conversations with users, wherein the artificial intelligence utilizes the first vector to generate a first response.

5. The method of claim 4, comprising:
utilizing, by the artificial intelligence, the second vector to generate a second response.

6. The method of claim 1, comprising:
in response to receiving a request from a downstream service for embedding data of the request into a vector, executing, using the second pipeline, a new embedding storage request event to embed the data of the request using the second embedding model to create the vector based upon the second model identifier indicating that the second embedding model is preferred over using the first embedding model associated with the first model identifier.

7. The method of claim 1, comprising:
defining the second pipeline to include instructions on inputting data into the second embedding model, selection criteria for choosing the second embedding model, and criteria for selecting an index.

8. The method of claim 1, comprising:
defining a name for the second pipeline, wherein the name is utilized as a prefix of indices.

9. The method of claim 1, comprising:
defining a first pipeline version for the first pipeline and a second pipeline version for the second pipeline.

10. The method of claim 1, comprising:
defining the second pipeline to receive query data and item data, wherein the second pipeline routes the query data and the item data into an index associated with an endpoint.

11. The method of claim 1, comprising:
defining the second pipeline with a vector size specifying a dimensionality for the second vector stored into the vector database.

12. The method of claim 1, comprising:
defining the second pipeline with a distance function for calculating a distance between two vectors created through the second pipeline.

13. The method of claim 1, comprising:
in response to identifying a dependency between indices during porting of a vector, reindexing a first model and a second model, corresponding to the dependency, together as part of porting the vector.

14. A computing device comprising:
a memory comprising machine executable code; and
a processor coupled to the memory, the processor configured to execute the machine executable code to cause the processor to perform operation comprising:
generating, utilizing a first pipeline of the vector as a service, a first vector using a first embedding model hosted by an inference service;
storing, through a dataset management service, the first vector into storage, wherein the first vector is assigned a first model identifier of the first embedding model;
constructing a second pipeline of the vector as a service to utilize a second embedding model having a second model identifier;
extracting, by a reindexer component, the first vector from the storage based upon the first vector being assigned a first model identifier different than the second model identifier of the second embedding model hosted by the inference service;
generating, by the reindexer component, an embedding storage request event to reindex and port the first vector from being embedded by the first embedding model to being embedded by the second embedding model; and
executing, using the second pipeline, the embedding storage request event to port the first vector into a second vector embedded by the second embedding model for storage within a vector database.

15. The computing device of claim 14, wherein the operations comprise:
utilizing, by a recommendation service, vectors within the vector database to construct and provide a content recommendation to a user.

16. The computing device of claim 14, wherein the operations comprise:
utilizing, by a service, vectors within the vector database to identify a set of nearest neighbors for use by the service to perform a task.

17. The computing device of claim 14, wherein the operations comprise:
utilizing, by a service, vectors within the vector database to execute a query for query item retrieval.

18. A non-transitory machine-readable storage medium comprising instructions that when executed by a machine, causes the machine to perform operations comprising:
generating, utilizing a first pipeline of the vector as a service, a first vector using a first embedding model hosted by an inference service;
storing, through a dataset management service, the first vector into storage, wherein the first vector is assigned a first model identifier of the first embedding model;
constructing a second pipeline of the vector as a service to utilize a second embedding model having a second model identifier;
extracting, by a reindexer component, the first vector from the storage based upon the first vector being assigned a first model identifier different than the second model identifier of the second embedding model hosted by the inference service;
generating, by the reindexer component, an embedding storage request event to reindex and port the first vector from being embedded by the first embedding model to being embedded by the second embedding model; and
executing, using the second pipeline, the embedding storage request event to port the first vector into a second vector embedded by the second embedding model for storage within a vector database.

19. The non-transitory machine-readable storage medium of claim 18, wherein the operations comprise:
utilizing, by a service, vectors within the vector database to perform a similarity search for entities represented by the vectors.

20. The non-transitory machine-readable storage medium of claim 18, wherein the operations comprise:
utilizing, by a service, vectors within the vector database to process service tickets with information derived from entities represented by the vectors.
